(19) United States
(12) Patent Application Publication
(10) Pub. No.: US 2025/0303441 A1
(43) Pub. Date: Oct. 2, 2025

(54) VISION-CONTROLLED PRECISION PAINT TOUCH-UP SYSTEM AND METHOD

(71) Applicant: Ford Global Technologies, LLC, Dearborn, MI (US)

(72) Inventors: Christopher Michael Seubert, New Hudson, MI (US); Marcy Ellen Zimmer, Shelby Twp., MI (US); Janice Lisa Tardiff, Plymouth, MI (US)

(73) Assignee: Ford Global Technologies, LLC, Dearborn, MI (US)

(21) Appl. No.: 18/616,504

(22) Filed: Mar. 26, 2024

(51) Int. Cl. B05D 5/06; B05B 12/08; B05B 13/02; B05B 13/04; B05D 7/00

(52) U.S. Cl. CPC B05D 5/06; B05B 12/084; B05B 13/0278; B05D 7/542; B05D 7/546; B05B 13/0431

(57) ABSTRACT

A method of coating a vehicle component, the method includes applying a first paint material to a target region of the vehicle component to produce a first paint coating across the target region and scanning, via an automated vision system, the target region to detect one or more imperfections in the first paint coating. The method further includes mapping, via a controller, one or more sub-regions of the first paint coating and identifying, via the controller, a subset of nozzles of a paint applicator. The subset of nozzles corresponding to the one or more sub-regions. The method further includes operating the paint applicator to eject the second paint material from the subset of nozzles and not from other nozzles of the plurality of nozzles to apply the second paint material to the one or more sub-regions.

### FIELD

The present disclosure relates to a precision paint touch-up system and method controlled by a vision system.

### BACKGROUND

The statements in this section merely provide background information related to the present disclosure and may not constitute prior art.

Current production paint equipment, such as rotary bell applicators, which are spinning disks that rotate at speeds greater the 50,000 rpms, atomize the paint using centrifugal force. The paint is ejected from an annular slot of the spinning disk and the paint is radially propelled to the edge of the disk to form ligaments which separate into droplets. The momentum of the paint droplets is directed parallel to the direction of the applicator. Compressed air is used to direct the spray pattern towards the vehicle component. Additionally, an electric field can be imposed between the paint applicator and the vehicle component and cooperates with charged paint droplets to steer the paint droplets toward the vehicle component to be painted.

The atomization process of the typical production paint applicator results in a broad particle size distribution. Occasionally, minor imperfections in the paint applied can occur that are smaller than the smallest distribution possible with such typical production paint applicators. Additionally, such imperfections are typically not found until after the paint has cured. Thus, typical production paint applicators can require time consuming sanding and masking operations to achieve precision application in order to correct such imperfections.

### SUMMARY

This section provides a general summary of the disclosure and is not a comprehensive disclosure of its full scope or all of its features.

In one form of the present disclosure, a method of coating a vehicle component includes: a) applying a first paint material to a target region of the vehicle component to produce an first paint coating across the target region; b) scanning, via an automated vision system, the target region to detect one or more imperfections in the first paint coating, each imperfection of the one or more imperfections being an area in the target region lacking a full thickness of application of the first paint material; c) mapping, via a controller, one or more sub-regions of the first paint coating, each sub-region of the one or more sub-regions being associated with a corresponding imperfection of the one or more imperfections, wherein the one or more sub-regions are less than an entirety of the target region; d) identifying, via the controller, a subset of nozzles of a paint applicator, the subset of nozzles corresponding to the one or more sub-regions, wherein the paint applicator includes a plurality of nozzles including the subset of nozzles, wherein the subset of nozzles includes less than all of the nozzles of the plurality of nozzles, wherein each nozzle of the plurality of nozzles includes: a nozzle plate that defines an aperture and partially defines a reservoir configured to hold a second paint material; and a piezoelectric actuator configured to vibrate the second paint material in the reservoir to eject the second paint material from the aperture; and e) operating the paint applicator to eject the second paint material from the subset of nozzles and not from other nozzles of the plurality of nozzles to apply the second paint material to the one or more sub-regions.

In variations of this method, which may be implemented individually or in combination: the application of the first paint material of step (a) is performed by the paint applicator and includes operating the paint applicator to eject the first paint material from a number of nozzles, of the plurality of nozzles, that is more than a total number of nozzles in the subset of; a camera of the automated vision system is mounted on the paint applicator and the scanning of step (b) occurs while the first paint coating is applied in step (a); the second paint material is a different color than the first paint material; each sub-region includes the area of the imperfection corresponding to that sub-region and a perimeter area surrounding the area of the imperfection corresponding to that sub-region; the steps (b) through (e) are done before the first paint coating is cured; step (e) is done after the first paint coating is cured; modifying a surface of at least a portion of each sub-region before step (e); step (e) includes adjusting an edge definition of the subset of nozzles to control a transition between the one or more sub-regions and the first paint coating; adjusting the edge definition includes adjusting at least one of a thickness and a number of drops per square inch of the second paint material applied along an outer edge of the one or more sub-regions; adjusting the edge definition includes at least one of decreasing a frequency of a waveform and decreasing a number of pulses of the waveform provided to the piezoelectric actuators of the nozzles associated with an outer edge of the one or more sub-regions; masking of the sub-region is not performed before step (e); a surface of the first paint coating is not modified before step (e); adjusting a waveform provided to the piezoelectric actuators during step (e) based on size of the one or more imperfections; and adjusting the waveform includes increasing at least one of a frequency of the waveform and a number of pulses of the waveform.

In another form of the present disclosure, a method of coating a vehicle component includes: a) operating a paint applicator to eject a first paint material from a plurality of nozzles of the paint applicator to apply the first paint material to a target region of the vehicle component to produce an first paint coating across the target region, wherein each nozzle of the plurality of nozzles includes: a nozzle plate that defines an aperture and partially defines a reservoir configured to hold the first paint material; and a piezoelectric actuator configured to vibrate the first paint material in the reservoir to eject the first paint material from the aperture; b) scanning, via an automated vision system, the target region to detect one or more imperfections in the first paint coating, each imperfection of the one or more imperfections being an area in the target region lacking a full thickness of application of the first paint material; c) mapping, via a controller, one or more sub-regions of the first paint coating, each sub-region of the one or more sub-regions being associated with a corresponding imperfection of the one or more imperfections, wherein the one or more sub-regions are less than an entirety of the target region; d) identifying, via the controller, a subset of nozzles of the plurality of nozzles as corresponding to the one or more sub-regions, wherein the subset of nozzles includes less than all of the nozzles of the plurality of nozzles; and e) operating the paint applicator to eject the first paint material from the subset of nozzles and not from other nozzles of the plurality of nozzles to apply the first paint material to the one or more sub-regions.

In variations of this method, which may be implemented individually or in combination: step (e) includes adjusting an edge definition of the subset of nozzles to control a transition between the one or more sub-regions and the first paint coating.

In yet another form of the present disclosure, a system for coating a vehicle component includes: an automated vision system configured to scan a target region of the vehicle component to detect one or more imperfections in an first paint coating on the vehicle component, each imperfection of the one or more imperfections being an area in the target region lacking a full thickness of application of a first paint material; a controller configured to map one or more sub-regions of the first paint coating, each sub-region of the one or more sub-regions being associated with a corresponding imperfection of the one or more imperfections, wherein the one or more sub-regions are less than an entirety of the target region; and a paint applicator, wherein the paint applicator includes a plurality of nozzles, wherein each nozzle of the plurality of nozzles includes: a nozzle plate that defines an aperture and partially defines a reservoir configured to hold a second paint material; and a piezoelectric actuator configured to vibrate the second paint material in the reservoir to eject the second paint material from the aperture, wherein the controller is configured to identify a subset of nozzles of the plurality of nozzles as corresponding to the one or more sub-regions, wherein the subset of nozzles includes less than all of the nozzles of the plurality of nozzles, and wherein the controller is configured to operate the paint applicator in a touchup mode in which the paint applicator ejects the second paint material from the subset of nozzles and does not eject from the other nozzles of the plurality of nozzles to apply the second paint material to the one or more sub-regions.

In variations of this system, which may be implemented individually or in combination: the controller is configured to operate the paint applicator in a transitioning mode to adjust an edge definition of the subset of nozzles to control a transition between the one or more sub-regions and the first paint coating; and the automated vision system includes a camera mounted on the paint applicator and the controller is configured to operate the automated vision system to scan the target region while operating the paint applicator to apply the first paint coating.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 depicts a schematic planar view of a paint application station, according to one form of the present disclosure;

FIG. 2 depicts a schematic planar view of a paint application station, according to a second form of the present disclosure;

FIG. 3 depicts a schematic planar view of a paint applicator, including a plurality of nozzles, for use in the paint application station of FIG. 1 or 2, according to one form of the present disclosure;

FIG. 4 depicts a schematic planar view of one of the nozzles of the paint applicator of FIG. 3, according to the present disclosure;

FIG. 5 depicts a schematic cross-sectional view of section 5-5 of the nozzle of FIG. 4, according to the present disclosure;

FIG. 6 depicts a schematic planar view of a target region of a vehicle component with an exemplary imperfection, according to one form of the present disclosure;

FIG. 7 depicts a schematic cross-sectional view of section 7-7 of the paint applicator of FIG. 3, according to the present disclosure;

FIG. 8 depicts a schematic representation of example waveforms provided to an actuator of a nozzle of the paint applicator of FIG. 3, according to one form of the present disclosure;

FIG. 9 is a flow diagram illustrating a method of detecting and touching-up imperfections in a target region of a vehicle component, according to one form of the present disclosure;

FIG. 10 is a flow diagram illustrating a method of detecting and touching-up imperfections in a target region of a cured vehicle component, according to one form of the present disclosure;

FIG. 11 depicts a schematic planar view of a paint applicator of a different form according to the present disclosure;

FIG. 12 depicts a schematic cross-sectional view of a portion of the paint applicator of FIG. 11, illustrating a nozzle of the paint applicator in a first state according to the present disclosure; and

FIG. 13 depicts a schematic cross-sectional view similar to FIG. 12, illustrating the nozzle in a second state according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

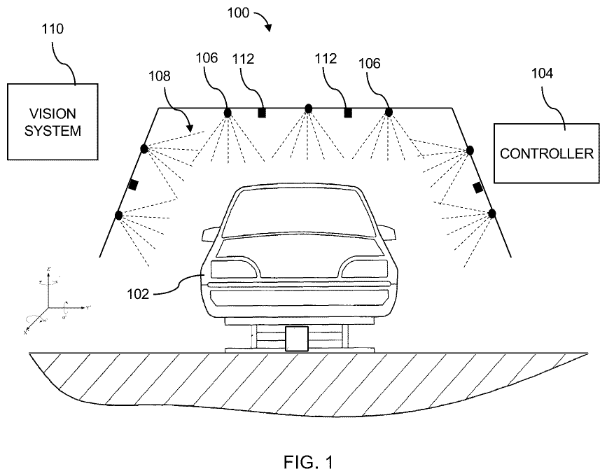

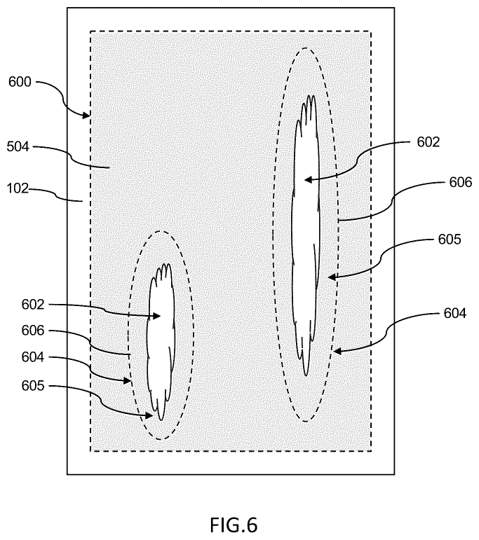

Referring to FIG. 1, a paint application station 100 includes at least one paint applicator 106 for applying a first paint material 108 to a target region 600 (best shown in FIG. 6) of a vehicle component 102 to produce one or more paint coatings (e.g., a first paint coating 504 (best shown in FIG. 6)) across the target region 600. The vehicle component 102 may include any number of components typically associated with a vehicle, from a door or body panel of the vehicle to the entirety of the vehicle and any number of components in between. While described herein with reference to a component of a vehicle, the teachings of the present application can be used to apply paint to any type of component, including components not associated with vehicles. As used herein, the term “paint” can include other types of materials besides those typically understood as providing a color surface, such as an anti-corrosion material, a primer, a clear coat, and the like.

In one form, the paint application station 100 may be a spray booth including at least one paint applicator 106 for applying the first paint material 108 to the target region 600 of the vehicle component 102. While FIG. 1 shows seven paint applicators 106, it is understood that any number of paint applicators 106 may be used. The paint applicators 106 may also be individually controllable such that all of the paint applicators do not need to operate at the same time.

In one form, the paint applicators 106 are positioned stationary and the vehicle component 102 moves relative to the paint applicators 106. In another form, the vehicle component 102 is stationary and the paint applicators 106 move relative to the vehicle component 102. In yet another form, both the vehicle component 102 and the paint applicators 106 can move relative to each other. Regardless of configuration, relative movement can be any suitable type of movement including translation and/or rotation relative to one or more axis (e.g., axes X, Y, Z).

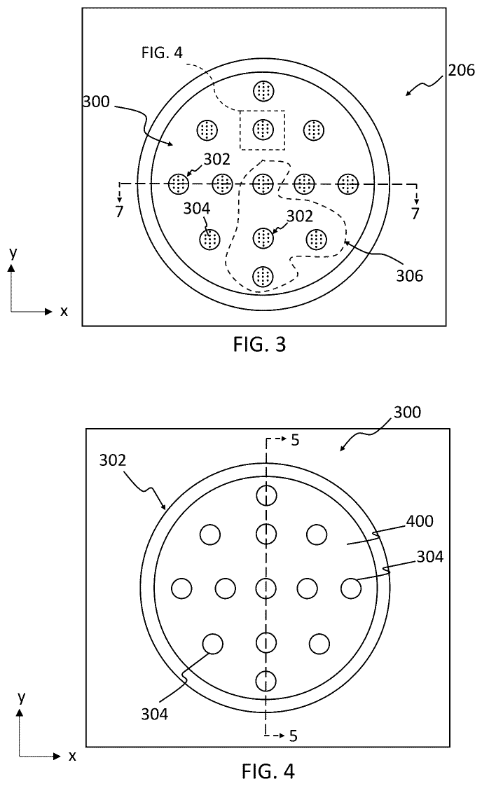

The paint applicator 106, in one form, may be a rotary bell applicator that atomizes the first paint material 108 using centrifugal force. The paint application station 100, may also include a compressed air system (not specifically shown) and an electric field system (not specifically shown) to utilize compressed air and/or an electric field, respectively, to direct a spray pattern of the first paint material 108 towards the vehicle component 102. In another form, the paint applicator 106 may be similar to the paint applicator 206, as shown in FIG. 3 and discussed in further detail below. As such, the application of the first paint material 108 can be, in one form, performed by the paint applicator 206, shown in FIG. 3-5 and discussed in further detail below.

Referring to FIGS. 1 and 6, the paint application station 100, may include a controller 104 and an automated vision system 110 with at least one camera 112. The at least one camera 112 of the automated vision system 110 scans (i.e., captures images and/or video of) the target region 600 of the vehicle component 102 to detect any imperfections 602 in the first paint coating 504. The automated vision system 110 processes the captured images and/or video and identifies imperfections 602. In one form, the automated vision system 110 identifies imperfections 602 as being unexpected changes in color difference or specular reflection off the first paint coating 504. The automated vision system 110 determines characteristics of the imperfections 602, such as size, location, and type, and conveys the information to the controller 104. In one form, the automated vision system 110 and the controller 104 can be individual systems in communication with each other, e.g., wirelessly or via wires (not shown). In another form, the automated vision system 110 can convey the images and/or video to the controller 104 and the controller 104 may process the images and/or video and identify the imperfections 602. In one form the automated vision system 110 may utilize machine learning to detect and classify imperfections 602.

In one form, the controller 104 and the automated vision system 110 with the at least one camera 112 may be integrated into the paint application station 100. As such, the at least one camera 112 may be mounted on or in proximity to the paint applicator 106 and scans the target region 600 of the vehicle component 102 to detect any imperfections 602 in the first paint coating 504 while the paint applicator 106 applies the first paint material 108 to the target region 600 of the vehicle component 102. In another form, the controller 104 and the automated vision system 110 with the at least one camera 112 may be integrated into the paint application station 100 but may instead scan the vehicle component 102 after the paint applicator 106 has completed applying the first paint material 108 to the target region 600.

In another form the controller 104 and automated vision system 110 with at least one camera 112 may be separate from the paint application station 100. As such the vehicle component 102 would be transported to the vision system 110 after the first paint material 108 is applied to the target region 600 of the vehicle component 102. The at least one camera 112 would then scan the target region 600 of the vehicle component 102 to detect any imperfections 602 in the first paint coating 504. In one form, the camera 112 scans that target region 600 before the vehicle component 102 is cured. In another form, the camera 112 scans the target region 600 after the vehicle component 102 is cured.

In one form, the at least one camera 112 can be positioned stationary and the vehicle component 102 moves relative to the camera 112. In another form, the vehicle component 102 is stationary and the camera 112 moves relative to the vehicle component 102. In yet another form, both the vehicle component 102 and the camera 112 can move relative to each other. Regardless of configuration, relative movement can be any suitable type of movement including translation and/or rotation relative to one or more axis (e.g., axes X, Y, Z).

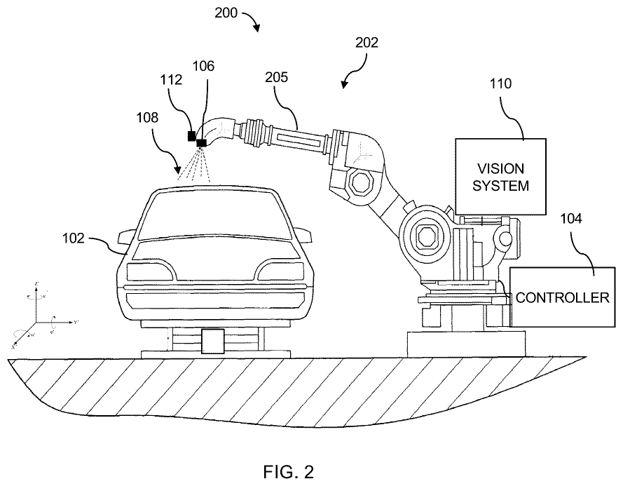

Referring to FIG. 2, a paint application station 200 of an alternate form includes a robotic system 202 for applying one or more paint coatings (e.g., the first paint coating 504 (FIG. 6)). In one form, at least one paint applicator 106 is disposed on a distal end of an arm 205 of the robotic system 202. The paint application station 200 may also include at least one camera 112.

The paint application station 200 may include a plurality of robotic systems 202 with either a paint applicator 106, a camera 112, or a combination of a paint applicator 106 and a camera 112 disposed on the arm 205 of each robotic system 202. Additionally, the robotic system 202 may include a plurality of arms 205 with one or more paint applicators 106, cameras 112, or a combination thereof disposed on each arm 205. Each arm 205 of the robotic system 202 can be articulated according to XYZ coordinates across a surface of the vehicle component 102 to guide at least one paint applicator 106 across a target region 600 of the vehicle component 102 to apply the first paint material 108 to the vehicle component 102.

In the example shown, the at least one camera 112 is mounted to the same arm 205 as the paint applicator 106. The camera 112 may scan the target region 600 while the paint applicator 106 is applying the first paint material 108. In an alternative form, the camera 112 may scan the target region 600 after the paint applicator 106 has finished applying the first paint material 108 to the target region 600.

In another form, the camera 112 can be mounted to a separate arm (not shown; similar to 205). In such a configuration, the arm with the camera 112 can follow the arm 205 as the paint applicator 106 applies the first paint material 108 to scan the target area while the first paint material 108 is being applied or the arm with the camera 112 can move the camera 112 over the vehicle component 102 after the first material 108 is finished being applied. In another form, the camera 112 may be on a separate structure (not shown) and can either scan the entire target region 600 from a single stationary position or can scan the target region 600 as the vehicle component 102 moves relative to the separate structure. As such, the camera 112 may scan the target region 600 before or after the first paint material 108 cures.

The robotic system 202 includes the controller 104 and the vision system 110 with the at least one camera 112. As discussed above with reference to the paint application station 100, the camera 112 scans the target region 600 of the vehicle component 102 to detect any imperfections 602 in the first paint coating 504.

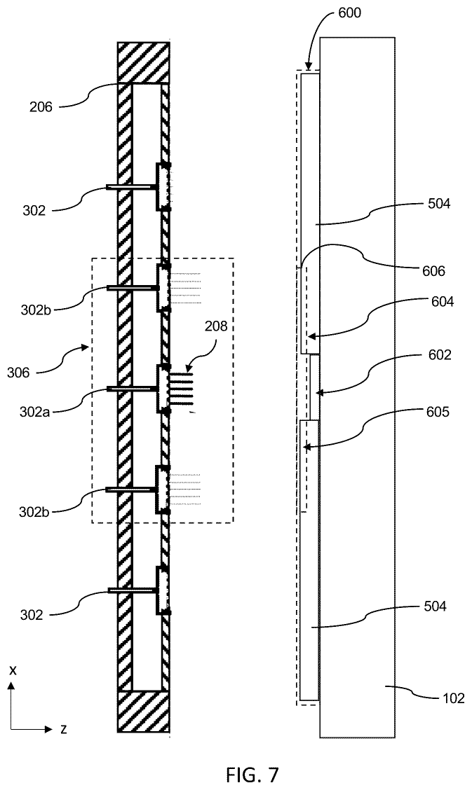

Referring to FIGS. 6 and 7, regardless of whether the paint application station 100 (FIG. 1) or the paint application station 200 (FIG. 2) or another paint application device (not shown) is used to apply the first paint coating 504, the camera 112 scans the target region 600 and the controller 104 (FIGS. 1 and 2) maps one or more sub-regions 604 (shown in FIG. 6) associated with one or more imperfections 602 of the first paint coating 504. The controller 104 then identifies a subset 306 of the nozzles 302, shown in FIG. 3, of a paint applicator 206 that correspond to the sub-regions 604. The subset 306 of the nozzles 302 can be a single nozzle 302 or more than one nozzle 302. This is because each nozzle 302 can be individually addressable (i.e., individually controllable).

The sub-regions 604 are less than an entirety of the target region 600. In one form, each sub-region 604 can be between the size of one nozzle 302 and the size of the paint applicator 206. In other words, the sub-region 604 can be as small as the paint resolution of a single nozzle 302 or as large as the paint resolution of all of the nozzles 302 of the paint applicator 206 combined. In one form, each sub-region 604 can be between 50 μm² and 100 mm², inclusive.

As discussed above, the paint applicator 206 of FIG. 3 can be the same paint applicator (e.g., paint applicator 106; FIGS. 1 and 2) that applied the first paint coating 504 or may be a different paint applicator. As such, the paint applicator 106 of FIGS. 1 and 2 may be constructed as shown and described with reference to the paint applicator 206. Regardless of whether the paint applicator 206 applied the first paint coating 504, the paint applicator 206 is incorporated into a paint application station similar to the paint application station 100 or 200 (FIG. 1 or 2) in place of the paint applicators 106.

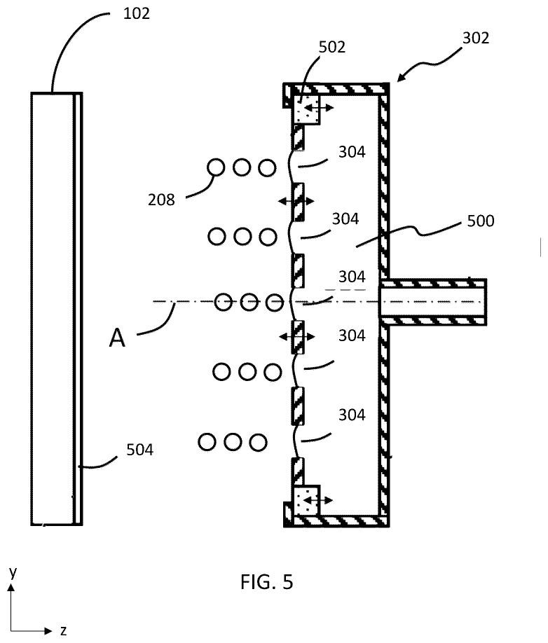

The paint applicator 206 then applies a second paint material 208 (FIGS. 5 and 7) to the sub-regions 604 within the target region 600 via the subset 306 of the nozzles 302 while not applying paint material from the other nozzles of the paint applicator 206 outside the sub-regions 604. In one form the second paint material 208 has a different structure than the first paint material 108, such as a different color. The first and second paint materials 108, 208 are generally a liquid material (e.g., primer, basecoat, clearcoat, etc.) but may optionally include interspersed solids, such as metallic flecks or other particles to provide a particular aesthetic. In another form, the second paint material 208 has the same structure as the first paint material 108.

As previously stated, the paint applicator 206 of the paint application station 200 may apply the first paint material 108 to the target region 600 of a vehicle component 102 to produce the first paint coating 504 across the target region 600. The second paint material 208 may be the same as the first paint material 108 and applied to the target region 600 of the vehicle component 102. In one form, the camera 112 may by mounted to or in proximity to the paint applicator 206 and scans the target region 600 of the vehicle component 102 to detect any imperfections 602 in the first paint coating 504 while the paint applicator 206 applies the first paint material 108 to the target region 600 of the vehicle component 102. The controller 104 may simultaneously map one or more sub-regions 604 associated with a corresponding imperfection of the first paint coating 504. The second paint material 208, which is the same as the first paint material 108 in this example, is then applied by the paint applicator 206 to the one or more sub-regions 604 within the target region 600 while not applied outside the sub-regions 604. The automated vision system 110 may optionally scan the sub-region 604 for imperfections 602 while the paint applicator 206 is applying the second paint material 208.

Referring to FIG. 3, the paint applicator 206 is schematically shown. In one form, the paint applicator 206 includes a plurality of nozzles 300. While FIG. 3 depicts the paint applicator 206 to be generally cylindrical in shape, any shape (e.g., cubical) may be suitable. Each nozzle 302 of the plurality of nozzles 300 is independently controllable. As such, each nozzle 302 can independently be activated or deactivated.

In response to detecting the imperfection 602, the controller 104 identifies a subset 306 of the nozzles 302 from the plurality of nozzles 300 where the subset 306 of the nozzles 302 includes less than all of the nozzles 302 of the plurality of nozzles 300. The subset 306 of the nozzles 302 correspond to one or more sub-regions 604, and may include as many or as few of the nozzles 302 of the plurality of nozzles 300 as needed to adequately apply the paint material 208 to the sub-region 604. The controller 104 can then selectively activates each nozzle 302 in the subset 306 of the nozzles 302 and not the other nozzles 302 of the plurality of nozzles 300.

In one variation, as previously discussed, the application of the first paint material 108 to the target region 600 of the vehicle component 102 to produce the first paint coating 504 across the target region 600 is performed by the paint applicator 206. When the application of the first paint material 108 is performed by the paint applicator 206 to produce the first paint coating 504 across the target region 600 the paint applicator 206 is operated to eject the first paint material 108 from a number of nozzles 302, of the plurality of nozzles 300, that is more than a total number of nozzles 302 in the subset 306 of the nozzles 302. In one from the number of nozzles 302 that eject the first paint material 108 includes all of the nozzles 302 from the plurality of nozzles 300. In another form the number of nozzles 302 may be more than the total number of nozzles 302 in the subset 306 of the nozzles 302 and less than the total number of nozzles 302 in the plurality of nozzles 300.

Each nozzle 302 of the plurality of nozzles 300 includes at least one aperture 304 through which a paint material 108, 208 is ejected through. While each nozzle 302 is shown with a plurality of apertures 304, each nozzle 302 could have any number of apertures 304, including only a single aperture 304. FIG. 4 depicts a detail view of a nozzle 302 of the plurality of nozzles 300. As shown, each nozzle 302 includes a nozzle plate 400 that defines at least one aperture 304 and partially defines a reservoir 500 (shown in FIG. 5) configured to hold the paint material 208. Each aperture 304 is sized such that surface tension of the paint material 108 or 208 inhibits the paint material from exiting the reservoir 500 through the apertures 304 when the nozzle 300 is not activated.

Referring to FIG. 5, a cross sectional view of a nozzle 302 of the paint applicator 206 while applying the paint material 208 to the vehicle component 102 is shown. The paint material 208 may be applied to a target region 600 to form the first paint coating 504 or may be applied to a sub-region 604 to touch-up the imperfection 602. Each nozzle 302 of the plurality of nozzles 300 of the paint applicator 206 includes a reservoir 500 and an actuator 502. In one form, the actuator 502 is a piezoelectric actuator 502 that when activated is configured to vibrate the paint material 208 (i.e., forms pressure waves within the paint material 208) in the reservoir 500 to eject the paint material 208 from the at least one aperture 304. In one form, the piezoelectric actuator 502 is a piezoelectric ceramic material that deforms when voltage is applied and changes the volume of the reservoir 500 to cause the paint material 208 to move within the reservoir 500 or otherwise produces pressure waves within the reservoir and eject from the at least one aperture 304. The actuator 502 of each nozzle 302 can be individually controlled by the controller 104 (FIG. 1) such that each nozzle 302 can be individually controlled.

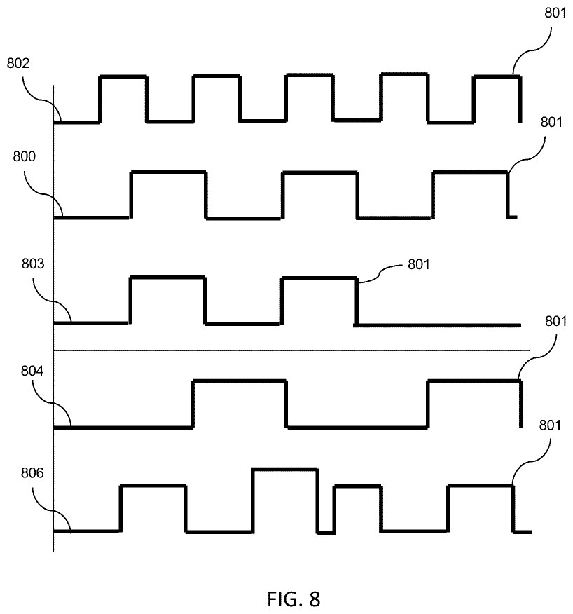

The vibration of the piezoelectric actuator 502 is controlled by a voltage waveform (e.g., waveform 800, 802, 803, 804, or 806, shown in FIG. 8), applied to the actuator 502. The paint material 208 ejected from the at least one aperture 304 is ejected as a droplet (i.e., in an atomized form). Each droplet can range in size and is dependent of the physical properties of the paint material 208, the paint applicator 206, and the waveform 800.

Referring to FIG. 8, different example waveforms (e.g., waveform 800, 802, 803, 804, 806) are illustrated. The waveform 800, 802, 803, 804, 806 is sent to the actuator 502 to activate the actuator 502 to vibrate the paint material 208 in the reservoir 500 to eject the paint material 208 from the at least one aperture 304. Each waveform 800, 802, 803, 804, 806 includes electrical pulses 801 that correspond to voltage being supplied to the actuator 502. Properties of the waveform 800, 802, 803, 804, 806, such as the number, amplitude, and frequency of the pulses 801, can be manipulated to control the actuator 502.

The size, or thickness, of the droplets from each nozzle 302 can be controlled by adjusting the number of pulses 801 of the waveform 800, 802, 803, 804, 806 communicated to the actuator 502. Adjusting the thickness of the droplets of the paint material 208 can control the thickness of the coating when the droplets contact the surface of the vehicle component 102. In this way, the thickness of the paint material 208 deposited can be controlled to create a feathering effect and control the transition between the sub-region 604 and the first paint coating 504 outside the sub-region. For example, by increasing the number of pulses 801, such as shown in waveform 802, the actuator 502 compresses the reservoir more times and thus produce droplets of the paint material 208 with an increased thickness. Decreasing the number of pulses 801, such as shown in waveform 803, the actuator 502 compresses the reservoir less times to produce droplets of the paint material 208 with a decreased thickness.

Additionally, controlling the amplitude of the pulses 801 of the waveform 800, 802, 803, 804, 806 communicated to the actuator 502 controls the size, or thickness, of the droplets of the paint material 208 ejected from the aperture 304 of each nozzle 302. For example, when the amplitude of the pulse 801 of the waveform is increased, such as that shown in waveform 806, the voltage supplied to the actuator 502 of the nozzle 302 is increased. This results in an increase in the expansion or contraction of the actuator 502, thus increasing the amount of paint material 208 ejected from the aperture 304 of the nozzle 302. Likewise, when the amplitude of the pulse 801 of the waveform 800, 802, 803, 804, 806 is decreased the voltage supplied to the actuator 502 of the nozzle 302 is decreased thus decreasing the expansion or contraction of the actuator 502 and decreasing the amount of material ejected.

Controlling the frequency of the pulses 801 of the waveform 800, 802, 803, 804, 806 communicated to the actuator 502 of each nozzle 302 controls the number of droplets per square inch (DPI) ejected from the aperture 304 of each nozzle 302 of the paint applicator 206. Controlling the DPI of the paint material 208 deposited can create a feathering effect and control the transition between the sub-region 604 and the first paint coating 504. For example, by increasing the frequency of the waveform, as shown by waveform 802, the actuator 502 vibrates faster to eject more droplets of the paint material 208 per square inch of area of the vehicle component. Alternatively, by decreasing the frequency, as shown by waveform 804, the actuator vibrates slower resulting in a reduced number of droplets of the paint material 208 per square inch of area of the vehicle component.

In one form, the waveform may include a mixed range of frequencies and amplitudes such as that shown in waveform 806. Waveform 806 includes pulses with a decreased amplitude and an increased amplitude. As shown, in one form the mixed waveform 806 may go from a decreased frequency to an increased frequency and back to a decreased frequency. The variation in the frequency and amplitude of the mixed waveform 806 facilitates a fine control of the vibration of the actuator 502, and thus DPI and the thickness of the droplets of the paint material 208. Controlling the thickness of the droplets of the paint material 208 is useful in controlling the transition between the sub-region 604 and the first paint coating 504 outside the sub-region 604.

Referring to FIG. 6, a vehicle component 102 with a first paint coating 504 across a target region 600 may include one or more imperfections 602. The one or more imperfections 602 are an area in the target region 600 lacking a full thickness of application of the first paint material 108. The imperfections 602 may be caused by a variety of factors such as variations in droplet size of the first paint material 108, loss of nozzle 302 function, and other similar factors. In one form, the imperfection 602 may be of a predetermined and intentionally produced geometry such as a logo, text, shape or pattern.

Each sub-region 604 of the one or more sub-regions 604 is associated with a corresponding imperfection 602. In one form, each sub-region 604 includes the area of the imperfection 602 corresponding to that sub-region 604 and a perimeter area 605 surrounding the area of the imperfection 602 corresponding to that sub-region 604. In one form, the perimeter area 605 of the sub-region 604 is adequately sized to facilitate a seamless transition between the paint material 208 applied to the imperfection 602 and the surrounding first paint coating 504. In other words, the perimeter area 605 can be sufficient to produce a feathering effect to visually blend the second paint material 208 into the first paint coating 504. In one form, such as but not limited to when the imperfection 602 is of a predetermined geometry, the sub-region 604 may be limited to the size and location of the corresponding imperfection 602 such that the sub-region 604 lacks any perimeter area 605.

In one form, such as when the imperfection 602 is of a predetermined geometry, the second paint material 208 is a different color and/or texture from the first paint material 108 that produces the first paint coating 504. Additionally, the edge definition of the droplets of the second paint material 208 from the subset 306 of the nozzles 302 can be controlled to provide a crisp edge between the paint material 208 applied to the sub-region 604 and the first paint coating 504. In one form, the thickness of the second paint material 208 applied at the sub-region 604 can be such that the second paint material 208 forms a flush surface with the first paint coating 504. In another form, the thickness of the second paint material 208 can be such that the second paint material 208 forms a raised or recessed surface relative to the first paint coating 504.

In one form, the edge definition of the droplets of the paint material 208 of the subset 306 of the nozzles 302 can be adjusted to control the transition between the sub-regions 604 and the first paint coating 504. Adjusting the edge definition includes adjusting at least one of a thickness and a DPI of the second paint material 208 applied along an outer edge 606 of the perimeter area 605 of the sub-region 604.

In one variation, adjusting the edge definition includes decreasing the frequency of a waveform 800 provided to the actuators 502 of the nozzles 302 associated with the outer edge 606 of the sub-regions 604 to decrease the DPI of the second paint material 208. The DPI of the second paint material 208 ejected from the subset 306 of the nozzles 302 decreases throughout the perimeter area 605 and up to the outer edge 606 of the sub-region 604. For example, the second paint material 208 applied at the imperfection 602 may have a larger DPI, while the DPI of the paint material 208 applied to the surrounding perimeter area 605 is gradually decreased up to the outer edge 606.

In another variation, adjusting the edge definition includes decreasing at least one of the amplitude and number of pulses 801 of the voltage waveform 800, 802, 803, 804, 806 provided to the actuators 502 of the nozzles 302 associated with the outer edge 606 of the sub-regions 604 to decrease the thickness of the paint material 208. The thickness of the paint material 208 ejected from the subset 306 of the nozzles 302 decreases throughout the perimeter area 605 and up to the outer edge 606 of the sub-region 604. For example, the paint material 208 applied at the imperfection 602 may have a full thickness, while the thickness of the paint material 208 applied to the surrounding perimeter area 605 is gradually decreased up to the outer edge 606.

In yet another variation, the amplitude, frequency, and number of pulses 801 of the waveform 800, 802, 803, 804, 806 can be controlled to adjust the thickness and the DPI of the second paint material 208 ejected from the nozzle 302 to control the transition between the sub-region 604 and the initial paint coating 504. By gradually adjusting the edge definition from the imperfection 602 through the perimeter area 605 to the outer edge 606 of the sub-region 604 a feathering effect is created. This results in a more seamless visual transition from the sub-region 604 to the surrounding first paint coating 504.

FIG. 7 depicts a schematic representation of the paint applicator 206 applying the second paint material 208 to a sub-region 604 of the vehicle component 102 with an imperfection 602 according to one form of the present disclosure. The first paint coating 504 is applied to the target region 600 of the vehicle component 102 using any suitable device. Within the target region 600 the imperfection 602 is detected and a sub-region 604 associated with the imperfection 602 is mapped. The controller 104 then identifies a subset 306 of the nozzles 302 of the paint applicator 206 that correspond to the sub-region 604. The paint applicator 206 then ejects the paint material 208 from the subset 306 of nozzles 302 and not from the other nozzles 302 of the plurality of nozzles 300 to apply the paint material 208 specifically to the sub-region 604. The controller 104 is configured to operate the paint applicator 206 in a transitioning mode to independently control the subset 306 of the nozzles 302 to adjust the edge definition of the subset 306 of the nozzles 302 to control the transition between the sub-region 604 and the first paint coating 504. Adjusting the edge definition includes independently adjusting at least one of the thicknesses and the DPI of the paint material 208 deposited from each of the nozzles 302a, 302b in the subset 306 of the nozzles 302 to the sub-region 604. In the example provided, the nozzles 302a aligns with the imperfection 602 and the nozzles 302b align with the perimeter area 605 and the nozzles 302b are controlled to eject a different thickness and/or DPI than the nozzle 302a to adjust the edge definition.

For instance, voltage waveforms sent to the actuator 502 of the nozzle 302a from the subset 306 of the nozzles 302 may have a higher frequency to provide a larger DPI of the paint material 208 as the nozzle 302a is aligned with the imperfection 602. The nozzles 302b that correspond to the sub-region 604 but are aligned with the outer edge 506 of the perimeter area 605 may have a waveform with a lower frequency provided to the actuator 502 to reduce the DPI of the droplet of the paint material 208. Alternatively or additionally, the waveforms sent to the actuator 502 of the nozzle 302a from the subset 306 of the nozzles 302 may have a higher number of pulses 801 to provide a thicker droplet of the paint material 208 as the nozzle 302a is aligned with the imperfection 602 while the nozzles 302b that correspond to the sub-region 604 but are aligned with the outer edge 506 of the perimeter area 605 may have a waveform with a lower number of pulses 801 sent to the actuator 502 to reduce the thickness of the droplet of the paint material 208.

Additionally, while not shown, the subset 306 of the nozzles 302 may include additional nozzles between the nozzles 302a and 302b that are sent a waveforms with a different frequency and/or number of pulses 801 between that of the higher frequency waveform sent to the nozzle 302a and the lower frequency waveform sent to the nozzles 302b. Independently controlling each nozzle 302a, 302b of the subset 306 of the nozzles 302 facilitates the control of the edge definition of the second paint material 208 applied to the sub-region 604 of the vehicle component 102. This in turn creates a feathering effect between the sub-region 604 and the first paint coating 504 to provide a seamless transition without the need for sanding, masking and/or buffing the first paint coating 504.

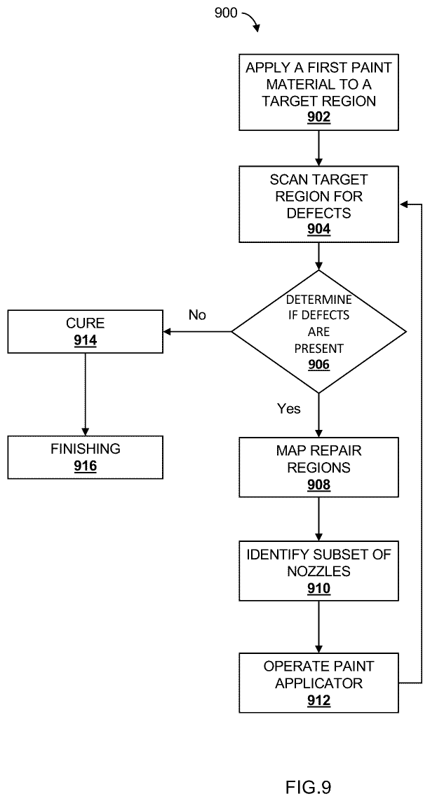

Referring to FIG. 9, a flowchart illustrating an example method 900 for coating the vehicle component 102 is provided. In step 902 the first paint material 108 is applied to the target region 600 of the vehicle component 102 to produce the first paint coating 504 across the target region 600 as discussed above.

In step 904 the automated vision system 110 scans the target region 600 for any imperfections 602 in the first paint coating 504, as discussed above. As discussed above, step 904 can occur subsequent to full completion of step 902 or the scanning of step 904 can occur while, i.e., concurrently with, the first paint coating 504 being applied in step 902.

In step 906, the controller 104 determines if there are one or more imperfections 602 present in the first paint coating 504. If no imperfections 602 are detected, then the method can continue to step 914. As discussed above, if there are imperfections 602, the controller 104 maps one or more sub-regions 604 of the first paint coating 504 in step 908.

In one form, the controller 104 uses the characteristics of the imperfections 602 to generate an image file of the sub-region 604 that is used to control the operation of the paint applicator 206. When using an image file, the paint applicator 206 can be controlled to produce droplets of the paint material 208 corresponding to pixels in the image file. The thickness and the DPI of the paint material 208 can be controlled to correspond to the image file. In another form, the controller 104 conveys the XYZ coordinates corresponding to the sub-regions 604 to the robotic system 202 to control the robotic arm 205 and the paint applicator 206.

In step 910, the controller 104 identifies the subset 306 of the nozzles 302 of the paint applicator 206 that correspond to the one or more sub-regions 604.

In one form, the controller 104 may include a plurality of controllers to perform the various functions. For example, the controller 104 may include a controller cooperatively engaged with the vision system to determine the sub-region 604 and another controller cooperatively engaged with the paint applicator 206 to determine the subset 306 of the nozzles 302. The controller 104 may include as many controllers as necessary to complete the intended steps. Alternately, the controller 104 may be a single controller 104.

Referring back to FIG. 9, in step 912 the controller 104 operates the paint applicator 206 in a touchup mode in which the paint applicator 206 ejects the paint material 208 from the subset 306 of the nozzles 302 and not from the other nozzles 302 of the plurality of nozzles 300 to apply the paint material 208 to the one or more sub-regions 604, as discussed above.

In one form, the paint application station 100 or 200 moves (or vehicle component 102 moves relative to the station 100) to a location corresponding to the sub-region 604 of the imperfection 602.

Steps 904 to 912 are repeated until the number of imperfections 602 detected are at or below a predetermined value. In one form, the predetermined value is zero. In one variation, steps 904-912 are repeated a set number of times before the vehicle component 102 or the paint applicator 206 is sent for alternate inspection or an operator is alerted. Once the number of imperfections 602 detected are at the predetermined value, the vehicle component 102 is cured in step 914. During the curing step 914, the paint material 108, 208 is bonded to the surface of the vehicle component 102. In one form, the curing in step 914 may involve the rapid circulation of air, the dehumidification of air, convection curing, infrared curing, ultraviolet curing, heated flash, thermal bake, electron beam, IR tunnel, or another type of curing process.

In step 916 the vehicle component 102 can be sent for finishing. In one form the finishing process includes applying a liquid material such as a clear coat. In yet another form, the method 900 is finished at step 916 and the vehicle component 102 is sent for final assembly.

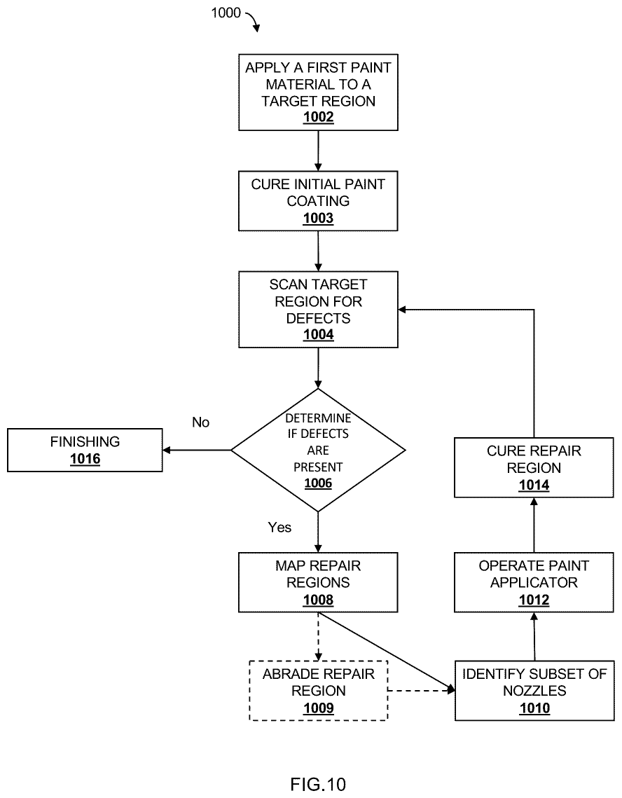

Referring to FIG. 10, a flowchart illustrating another example method 1000 for coating the vehicle component 102 is provided. In step 1002 the first paint material 108 is applied to the target region 600 of the vehicle component 102 to produce the first paint coating 504 across the target region 600, as discussed above.

In step 1003 the first paint coating 504 is cured. During the curing step 914, the paint material 108, 208 is bonded to the surface of the vehicle component 102. In one form, the curing in step 914 may involve the circulation of air, the dehumidification of air, convection curing, infrared curing, ultraviolet curing, heated flash, thermal bake, electron beam, IR tunnel, or another type of curing process.

In step 1004 the automated vision system 110 scans the target region 600 for any imperfections 602 in the first paint coating 504, as discussed above.

In step 1006, the controller 104 determines if there are one or more imperfections 602 present in the first paint coating 504. If there are no imperfections 602, then the vehicle component 102 can be sent for finishing at step 1016. If there are imperfections 602, then the controller 104 maps one or more sub-regions 604 of the first paint coating 504 in step 1008, as discussed above.

In one form, a surface modification is optionally applied to at least a portion (e.g., just the perimeter area 605, or the entire sub-region 604 including the perimeter area 605) of the sub-region 604 in step 1009. In one variation, the surface modification involves at least one of abrading, sanding, polishing, plasma treating, or applying clay bar to the portion of the sub-region 604. The surface modification erodes the cured surface of the first paint coating 504 to facilitate the application of the second paint material 208 to the sub-region 604 such that the second paint material 208 will adhere to the sub-region 604. Applying a surface modification aids in ensuring a smooth transition between the sub-region 604 and the first paint coating 504.

In step 1010, the controller 104 identifies the subset 306 of the nozzles 302 of the paint applicator 206 that correspond to the one or more sub-regions 604, as discussed above. In one form, step 1010 may be done subsequently to step 1009. In another form, step 1010 may be done subsequently to step 1008 and concurrently with step 1009. In yet another form, step 1010 may be done subsequently to step 1008 without performing step 1009.

In step 1012 the paint applicator 206 moves to a location corresponding to the sub-region 604 of the imperfection 602 and the controller 104 is configured to operate the paint applicator 206 in a touchup mode in which the paint applicator 206 is configured to eject the second paint material 208 from the subset 306 of the nozzles 302 and not from the other nozzles 302 to apply the paint material 208 to the one or more sub-regions 604, as discussed above.

Then, in step 1014 the sub-region 604 of the vehicle component 102 is cured. In one form curing the sub-region 604 of the vehicle component 102 involves sending the entire vehicle component 102 to a curing oven. In another form, the sub-region 604 of the vehicle component 102 may be isolated and cured via a localized curing system.

Steps 1004 to 1014 are repeated until the number of imperfections 602 detected are at or below a predetermined value. In one form, the predetermined value is zero. In one variation, steps 1004 to 1014 are be repeated a set number of times before the vehicle component 102 or the paint applicator 206 is sent for alternate inspection or an operator is alerted. Once the number of imperfections 602 detected are below the predetermined value the vehicle component 102 is sent for finishing in step 1016, which can be similar to step 916 (FIG. 9). In yet another form, the method 1000 is finished at step 1016 and the vehicle component 102 is sent for final assembly.

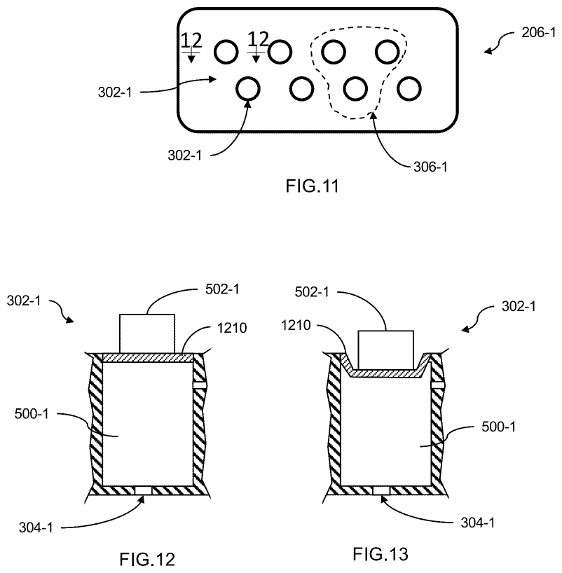

Referring to FIGS. 11 through 13, an alternative form of the paint applicator 206 is illustrated and indicated by reference numeral 206-1. The paint applicator 206-1 can be similar to the paint applicator 206 except as otherwise shown and described herein. As such, similar features are indicated with similar reference numbers but with a “-1” suffix and only differences are described in detail.

The paint applicator 206-1 includes a plurality of nozzles 302-1. In the example provided, the nozzles 302-1 are arranged in a rectangular linear array, though other shapes and arrangements can be used, such as circular, similar to that shown in FIGS. 3 and 4 for example. Each nozzle 302-1 includes at least one aperture 304-1, a reservoir 500-1, and an actuator 502-1.

The actuator 502-1 can be similar to the actuator 502 but is configured to expand and contract the size of the reservoir 500-1 to eject liquid from the reservoir 500-1 through the aperture 304-1. In the example provided, the actuator 502-1 is configured to deform a membrane 1210 that partially defines the reservoir 500-1 but does not define the aperture 304-1. The reservoirs 500-1 are separate from one another and the actuator 502-1 of each nozzle 302-1 can be individually controlled by the controller 100 (FIG. 1) similar to the reservoirs 500 and actuators 502 discussed above with reference to FIGS. 3-10. In other words, each nozzle 302-1 is individually addressable (i.e., individually controllable). As such, subsets 306-1 of the nozzles 302-1 can be identified and controlled by the controller 100 as discussed above with reference to FIGS. 3-10.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of coating a vehicle component, the method comprising:
a) applying a first paint material to a target region of the vehicle component to produce a first paint coating across the target region;
b) scanning, via an automated vision system, the target region to detect one or more imperfections in the first paint coating, each imperfection of the one or more imperfections being an area in the target region lacking a full thickness of application of the first paint material;
c) mapping, via a controller, one or more sub-regions of the first paint coating, each sub-region of the one or more sub-regions being associated with a corresponding imperfection of the one or more imperfections, wherein the one or more sub-regions are less than an entirety of the target region;
d) identifying, via the controller, a subset of nozzles of a paint applicator, the subset of nozzles corresponding to the one or more sub-regions, wherein the paint applicator includes a plurality of nozzles including the subset of nozzles, wherein the subset of nozzles includes less than all of the nozzles of the plurality of nozzles, wherein each nozzle of the plurality of nozzles includes:
a nozzle plate that defines an aperture and partially defines a reservoir configured to hold a second paint material; and
a piezoelectric actuator configured to vibrate the second paint material in the reservoir to eject the second paint material from the aperture; and
e) operating the paint applicator to eject the second paint material from the subset of nozzles and not from other nozzles of the plurality of nozzles to apply the second paint material to the one or more sub-regions.

2. The method of claim 1, wherein the application of the first paint material of step (a) is performed by the paint applicator and includes operating the paint applicator to eject the first paint material from a number of nozzles, of the plurality of nozzles, that is more than a total number of nozzles in the subset of nozzles.

3. The method of claim 2, wherein a camera of the automated vision system is mounted on the paint applicator and the scanning of step (b) occurs while the first paint coating is applied in step (a).

4. The method of claim 1, wherein the second paint material is a different color than the first paint material.

5. The method of claim 1, wherein each sub-region includes the area of the imperfection corresponding to that sub-region and a perimeter area surrounding the area of the imperfection corresponding to that sub-region.

6. The method of claim 1, wherein the steps (b) through (e) are done before the first paint coating is cured.

7. The method of claim 1, wherein step (e) is done after the first paint coating is cured.

8. The method of claim 7, further comprising modifying a surface of at least a portion of each sub-region before step (e).

9. The method of claim 1, wherein step (e) includes adjusting an edge definition of the subset of nozzles to control a transition between the one or more sub-regions and the first paint coating.

10. The method of claim 9, wherein adjusting the edge definition includes adjusting at least one of a thickness and a number of drops per square inch of the second paint material applied along an outer edge of the one or more sub-regions.

11. The method of claim 9, wherein adjusting the edge definition includes at least one of decreasing a frequency of a waveform and decreasing a number of pulses of the waveform provided to the piezoelectric actuators of the nozzles associated with an outer edge of the one or more sub-regions.

12. The method of claim 1, wherein masking of the sub-region is not performed before step (e).

13. The method of claim 1, wherein a surface of the first paint coating is not modified before step (e).

14. The method of claim 1, further comprising adjusting a waveform provided to the piezoelectric actuators during step (e) based on size of the one or more imperfections.

15. The method of claim 14, wherein adjusting the waveform includes increasing at least one of a frequency of the waveform and a number of pulses of the waveform.

16. A method of coating a vehicle component, the method comprising:
a) operating a paint applicator to eject a first paint material from a plurality of nozzles of the paint applicator to apply the first paint material to a target region of the vehicle component to produce an first paint coating across the target region, wherein each nozzle of the plurality of nozzles includes:
a nozzle plate that defines an aperture and partially defines a reservoir configured to hold the first paint material; and
a piezoelectric actuator configured to vibrate the first paint material in the reservoir to eject the first paint material from the aperture;
b) scanning, via an automated vision system, the target region to detect one or more imperfections in the first paint coating, each imperfection of the one or more imperfections being an area in the target region lacking a full thickness of application of the first paint material;
c) mapping, via a controller, one or more sub-regions of the first paint coating, each sub-region of the one or more sub-regions being associated with a corresponding imperfection of the one or more imperfections, wherein the one or more sub-regions are less than an entirety of the target region;
d) identifying, via the controller, a subset of nozzles of the plurality of nozzles as corresponding to the one or more sub-regions, wherein the subset of nozzles includes less than all of the nozzles of the plurality of nozzles; and
e) operating the paint applicator to eject the first paint material from the subset of nozzles and not from other nozzles of the plurality of nozzles to apply the first paint material to the one or more sub-regions.

17. The method of claim 16, wherein step (e) includes adjusting an edge definition of the subset of nozzles to control a transition between the one or more sub-regions and the first paint coating.

18. A system for coating a vehicle component, the system comprising:
an automated vision system configured to scan a target region of the vehicle component to detect one or more imperfections in an first paint coating on the vehicle component, each imperfection of the one or more imperfections being an area in the target region lacking a full thickness of application of a first paint material;
a controller configured to map one or more sub-regions of the first paint coating, each sub-region of the one or more sub-regions being associated with a corresponding imperfection of the one or more imperfections, wherein the one or more sub-regions are less than an entirety of the target region; and
a paint applicator, wherein the paint applicator includes a plurality of nozzles, wherein each nozzle of the plurality of nozzles includes:
a nozzle plate that defines an aperture and partially defines a reservoir configured to hold a second paint material; and
a piezoelectric actuator configured to vibrate the second paint material in the reservoir to eject the second paint material from the aperture,
wherein the controller is configured to identify a subset of nozzles of the plurality of nozzles as corresponding to the one or more sub-regions, wherein the subset of nozzles includes less than all of the nozzles of the plurality of nozzles, and wherein the controller is configured to operate the paint applicator in a touchup mode in which the paint applicator ejects the second paint material from the subset of nozzles and does not eject from the other nozzles of the plurality of nozzles to apply the second paint material to the one or more sub-regions.

19. The system of claim 18, wherein the controller is configured to operate the paint applicator in a transitioning mode to adjust an edge definition of the subset of nozzles to control a transition between the one or more sub-regions and the first paint coating.

20. The system of claim 18, wherein the automated vision system includes a camera mounted on the paint applicator and the controller is configured to operate the automated vision system to scan the target region while operating the paint applicator to apply the first paint coating.
